(19) United States
(12) Patent Application Publication
(10) Pub. No.: US 2006/0230669 A1
(43) Pub. Date: Oct. 19, 2006

(54) Fishing pole handle attachments and fishing pole handle

(76) Inventors: Duane C. Markley, Spokane Valley, WA (US); Ron Stokes, Spokane Valley, WA (US)

Correspondence Address: WELLS ST. JOHN P.S., 601 W. FIRST AVENUE, SUITE 1300, SPOKANE, WA, 99201, US

(21) Appl. No.: 11/370,675

(22) Filed: Mar. 7, 2006

Related U.S. Application Data
(60) Provisional application No. 60/659,204, filed on Mar. 7, 2005.

(51) Int. Cl. A01K 87/00

(52) U.S. Cl. 43/23; 43/25; 43/18.1 R

(57) ABSTRACT

A fishing pole handle is provided with a first handle component and a second handle component. The first handle component has a first reel seat, a rod connector provided at a proximal end, and a first component connector provided at a distal end. The second handle component has a second reel seat and a second component connector provided at a proximal end.

### RELATED PATENT DATA

This application claims priority from U.S. Provisional Patent Application Ser. No. 60/659,204, which was filed Mar. 7, 2005, and which is incorporated by reference herein.

### TECHNICAL FIELD

This invention pertains to fishing poles and fishing pole handles. More particularly, the present invention relates to handle components, handle attachments and handle assemblies for adapting the configuration of fishing pole handles.

### BACKGROUND OF THE INVENTION

Fishing poles are traditionally constructed with a handle and a rod, where the rod has a plurality of line guides spaced apart along the rod. In most cases, the rod is a straight rod that has been constructed to perform a specific type of fishing operation. For example, fishing poles are constructed as casting poles, trolling poles, fly fishing poles, spin casting poles, and ice fishing poles.

Additionally, fishing pole handles are constructed with a reel seat to mount a fishing reel onto the handle. Typically, the reel seat is on top of the handle for receiving bait casting reels and level wind trolling reels. For open face spin casting, the reel seat sits underneath the handle. In both of these configurations, the reel seat sits about six inches to eighteen inches from the end of the pole handle. For fly fishing, the reel seat is mounted along a distal end of the handle.

### SUMMARY OF THE INVENTION

According to one aspect, a fishing pole handle is provided with a first handle component and a second handle component. The first handle component has a first reel seat, a rod connector provided at a proximal end, and a first component connector provided at a distal end. The second handle component has a second reel seat and a second component connector provided at a proximal end.

According to another aspect, a fishing pole handle is provided with a first handle component and a second handle component. The first handle component has a reel seat, a rod connector, and a first component connector. The rod connector is provided at a proximal end. The first component connector is provided at a distal end. The second handle component has a second component connector provided at a proximal end.

According to yet another aspect, a fishing pole is provided having a rod, a handle, and a handle extension. The handle is connected with the rod and has a first component connector at a distal end. The handle extension has a second component connector provided at a proximal end and is configured to removably mate the handle extension onto the handle.

### BRIEF DESCRIPTION OF THE DRAWINGS

Preferred embodiments of the invention are described below with reference to the following accompanying drawings.

FIG. 1 is a side elevational view of one fishing pole configured for use with the present invention.

FIG. 2 is a side elevational view of a handle from the fishing pole of FIG. 1 and showing a component connector usable with the present invention, as well as usable with a removable balancing system.

FIG. 3 is a side elevational view of another handle for a combination spin casting/trolling fishing pole configured as a spin casting fishing pole and usable with the present invention.

FIG. 4 is a side elevational view of the fishing pole of FIG. 3 but with the handle rotated 90 degrees to provide a trolling fishing pole usable with the present invention.

FIG. 5 is an extension handle component according to one aspect of the present invention and configured for removable attachment to the component connector on each of the fishing rods of FIGS. 1-4.

FIG. 6 is another extension handle component according to another aspect of the present invention and also configured for removable attachment to the component connector on each of the fishing rods of FIGS. 1-4.

FIG. 7 is yet another extension handle component similar to that depicted in FIG. 6 and removably affixed onto a distal end of the handle for the fishing pole of FIG. 3.

FIG. 8 is a side elevational view of yet even another fishing pole with a pair of the extension handle components of FIG. 7 connected in series onto a distal end of the handle component of the handle.

FIG. 9 is a side elevational view of the fishing pole of FIG. 3 with extension handle components similar to those depicted in FIGS. 6 and 7.

FIG. 10 is an enlarged partial and breakaway view of a rotational lock and alignment assembly for adjusting and fixing the rear extension handle component of FIG. 10 onto a fishing pole handle.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

Reference will now be made to preferred embodiments of Applicant's invention comprising a handle component for adapting a user configuration of a fishing pole handle. While the invention is described by way of preferred embodiments, it is understood that the description is not intended to limit the invention to such embodiments, but is intended to cover alternatives, equivalents, and modifications which may be broader than the embodiments, but which are included within the scope of the appended claims.

In an effort to prevent obscuring the invention at hand, only details germane to implementing the invention will be described in great detail, with presently understood peripheral details being incorporated by reference, as needed, as being presently understood in the art.

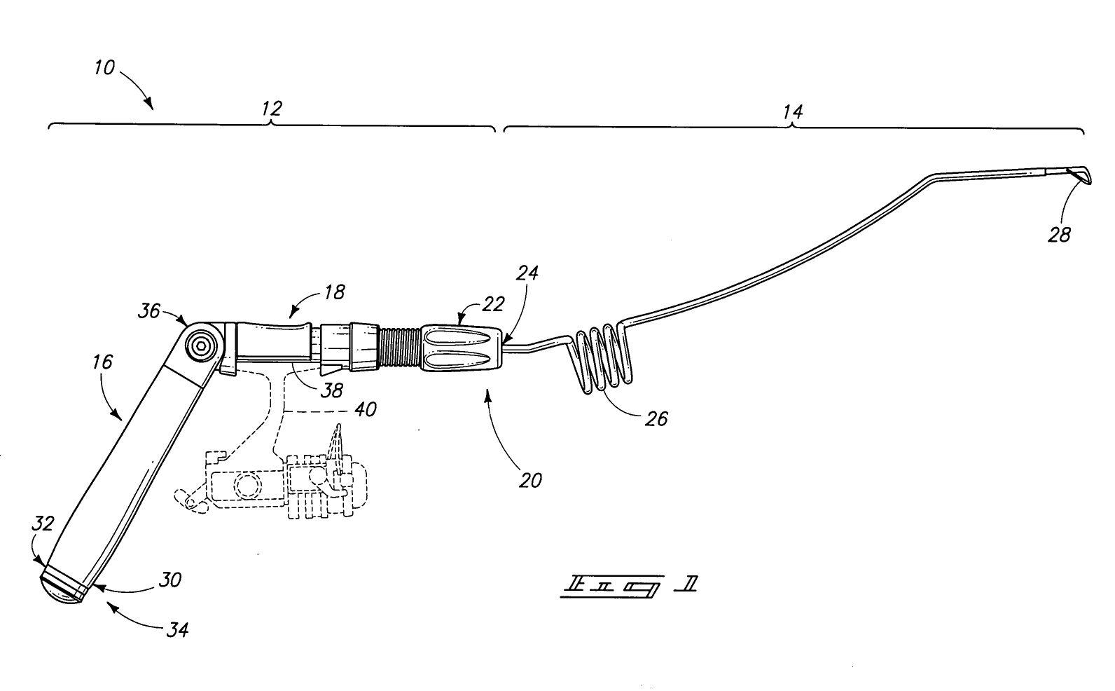

FIG. 1 illustrates a fishing pole 10 having a handle 12 and rod 14 that are removably coupled together. The moment of inertia of pole 10 can be tailored using an adjustable weight assembly 34 pursuant to techniques that are disclosed in U.S. Pat. No. 6,931,781; U.S. Pat. No. 6,922,936; and U.S. patent application Ser. No. 10/679,224 entitled “Fishing Poles, Conter-Balancing Apparatus for Fishing Poles and Fishing Pole Handles,” all of which are herein incorporated by reference.

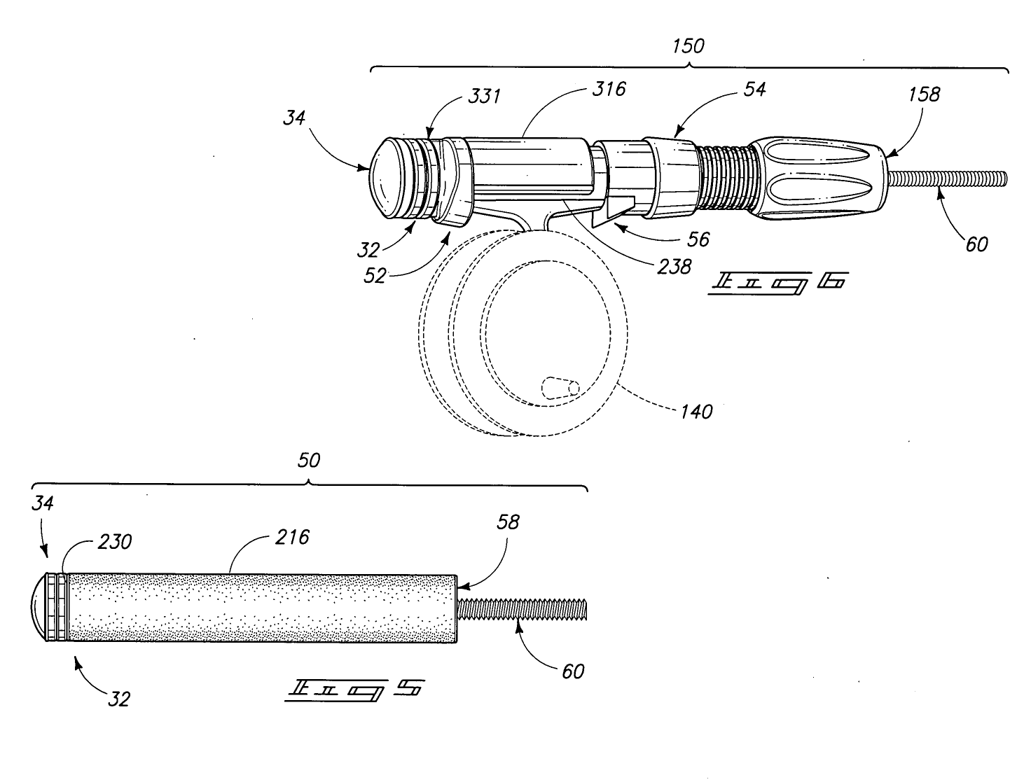

Fishing pole 10 comprises one fishing pole having a handle 12 that is configured for use with the present invention; namely, a fishing pole 10, handle 12, and one of several extension handle components 50, 150 and 250 (see FIGS. 5, 6 and 7, respectively) which can be removably mated to a distal end of a handle component 16 on handle 12.

As shown in FIG. 1, rod 14 is removably connected to handle 12 via a connector assembly 24 which is described in U.S. Pat. No. 6,922,936, previously incorporated by reference. More particularly, a male connector on rod 14 is axially and rotatably received and releasably engaged into a female connector 22 of handle 12. An adjustable locking hinge 36 is configured for adjusting the angle between handle component 16 and a reel seat handle component 18 of handle 12. Further details of the construction of hinge 36 are disclosed in U.S. patent application Ser. No. 11/058,838 entitled “Fishing Pole Handle Hinge Assembly and Fishing Pole Handle,” herein incorporated by reference. Handle component 18 includes a reel seat 38 onto which a spin casting reel 40 can be removably received between a pair of collars via a threaded locking ring, as presently understood in the art.

Rod 14 includes a coil spring 26 spaced from male connector 20 and a tip end ferrule 28. However, it is understood that other constructions for a rod can also be utilized and interchanged with handle 12, and that coil spring 26 is not necessary in order to practice the present invention. Further alternatively, handle 12 and rod 14 can be permanently affixed together as a single unit.

Handle component 16 includes a component connector 30 provided at a distal end of handle component 16 for removably receiving an array 32 of corrector weights that are used to balance fishing pole 10. Array 32 is removed in order to add an extension handle component of the present invention.

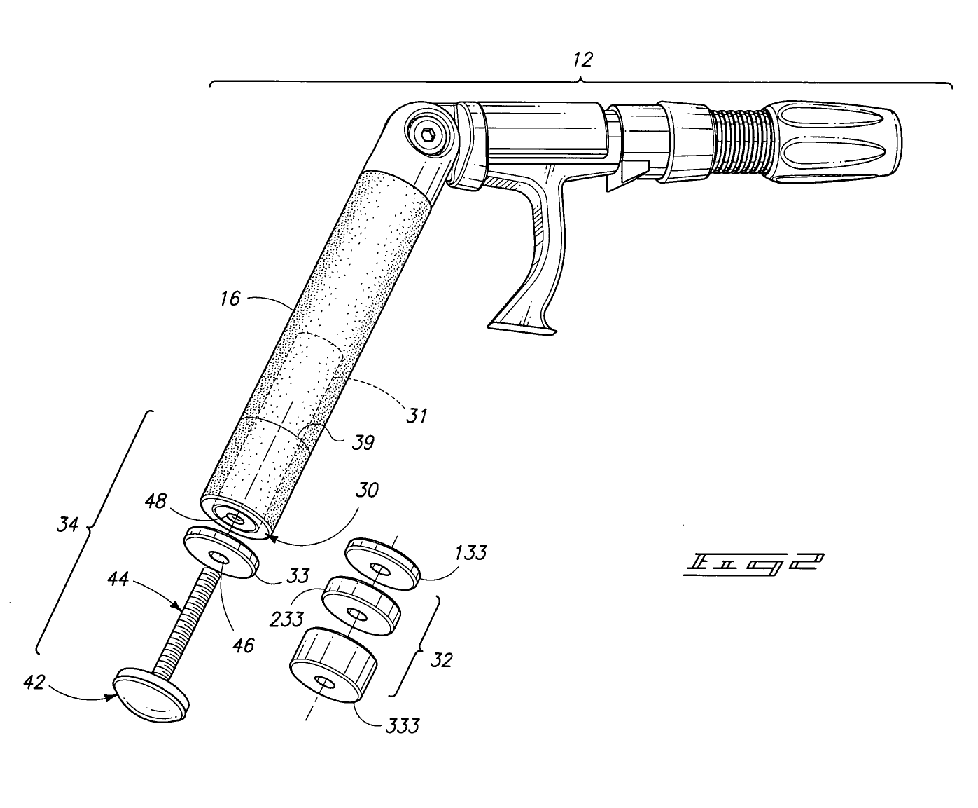

As shown in FIG. 2, handle 12 includes handle component 16 onto which adjustable weight assembly 34 is removably received. More particularly, component connector 30 with a brass, or bronze mounting slug 31 is affixed within a distal end of handle component 16 to provide a threaded bore 48 (provided in slug 31 that is inserted within handle component 16 where it is adhesively affixed therein). Component connector 30 is provided within a distal end of handle component 16 to enable dual use mounting of components onto a distal end of handle component 16. As shown in FIG. 2, adjustable weight assembly 34 is affixed onto handle component 16. However, component connector 30 is also used in order to affix extension handle components onto handle 12, such as extension handle components 50, 150 and 250 (see FIGS. 5, 6 and 7 respectively).

As shown in FIG. 2, a threaded fastener 42 (having an enlarged head) has a threaded shank 44 that is received in threaded engagement within complementary threaded bore 48 of handle component 16. One or more of corrector weights 33, 133, 233 and 333 are selected from array 32 for removable mounting via fastener 42 onto a distal end of handle component 16. A bore 46 within corrector weight 33 receives shank 44 during assembly so as to entrap corrector weight 33 securely against a distal end of handle component 16.

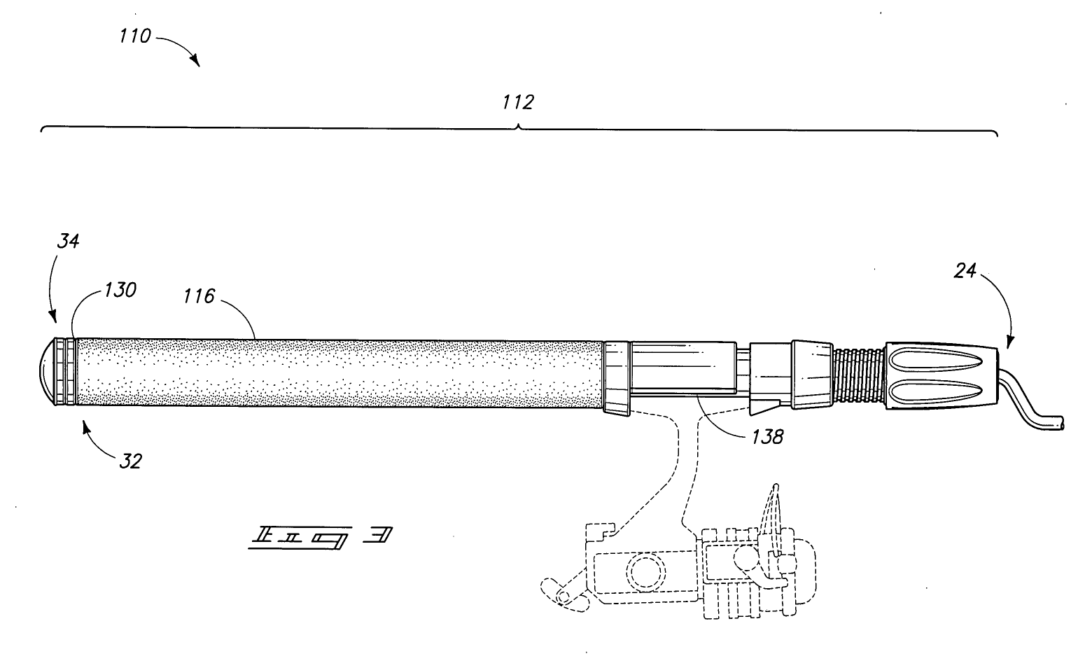

FIG. 3 illustrates another fishing pole 110 having an alternatively constructed spin casting handle 112 that also includes a rod (not completely shown), but which is a variation of rod 14 as shown in FIG. 1. The rod is affixed via connector assembly 24 onto handle 112, and a reel seat 138 is provided for affixing a spin casting reel thereto. A handle component 116 on handle 112 also includes a component connector 130 (substantially the same as connector 30 in FIGS. 1-2) that is configured to receive extension components as well as the adjustable weight assembly 34 onto a distal end of handle component 116. Adjustable weight assembly 34 includes an array 32 of corrector, or balance weights for balancing out the moment of inertia for fishing pole 110. Component connector 130 is also configured for receiving the extension handle components 50, 150 and 250 (see FIGS. 5-7, respectively).

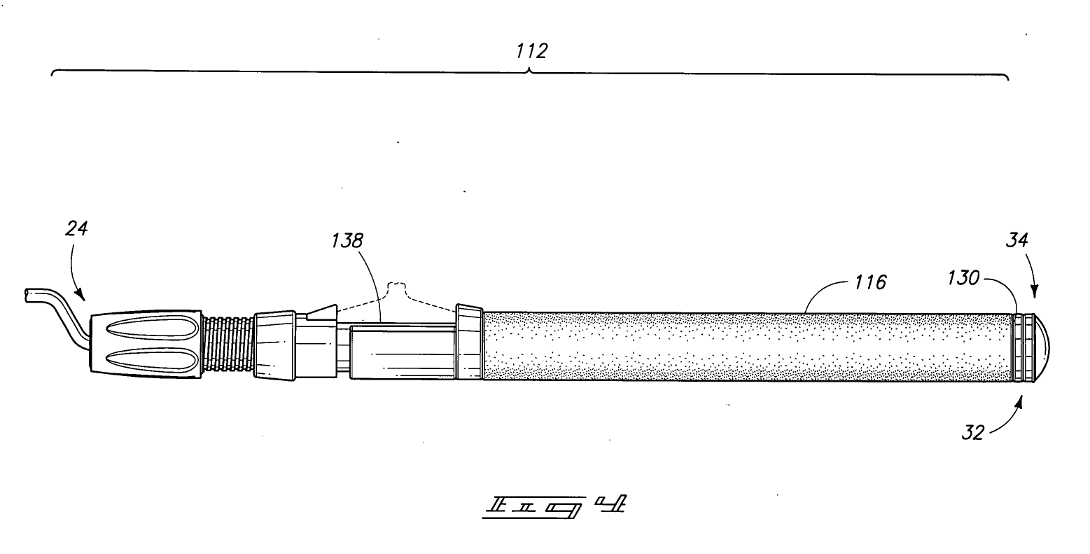

FIG. 4 illustrates an alternative configuration for handle 112, wherein a different rod is affixed onto handle 112 via connector 24 where handle component 116 is rotated 180 degrees relative to the rod such that reel seat 138 is presented on a topmost surface (in contrast to the bottommost surface depicted in FIG. 3). Adjustable weight assembly 34 is also affixed onto component connector 130 for attaching array 32 of weights thereon, as well as for alternatively attaching an extension handle component as previously discussed.

FIG. 5 illustrates the construction of one suitable extension handle component 50 that is usable on the fishing pole handles 12 and 112 depicted in FIGS. 1-4. Handle component 50 is configured to extend the length of the respective handle components 16 and 116 on the respective handles 12 and 112 in order to provide greater leverage to a user of such fishing pole when casting or when retrieving a fish.

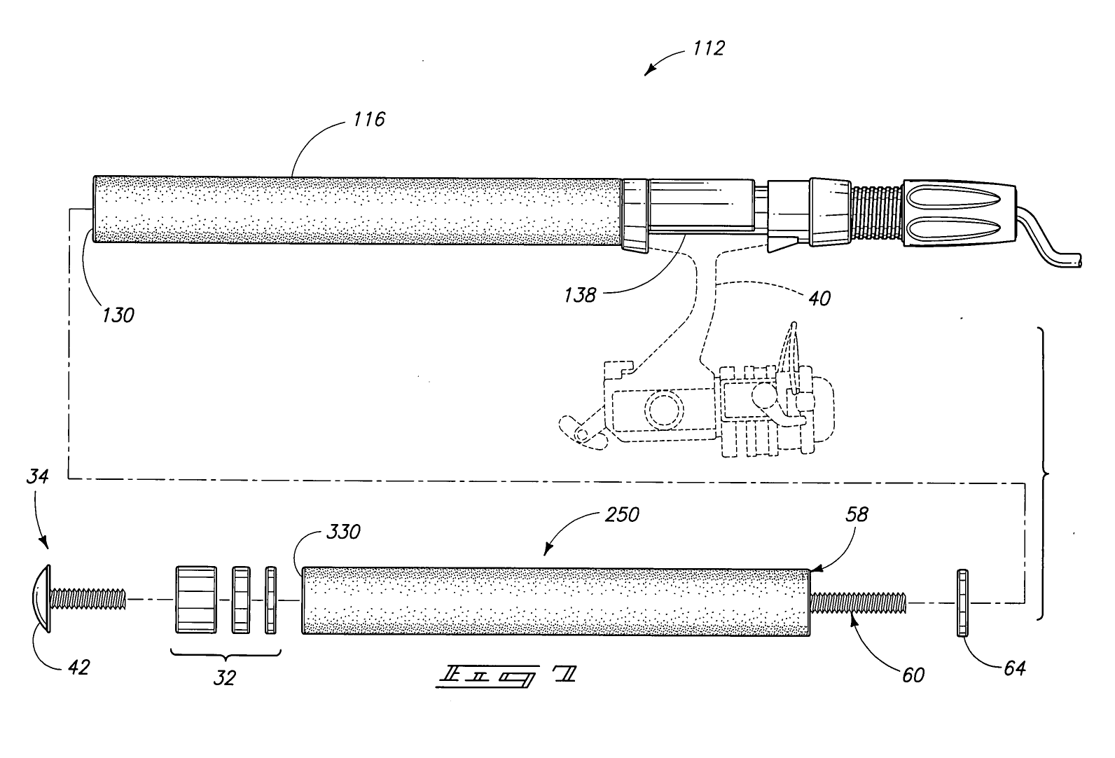

More particularly, extension handle component 50 is typically formed from a piece of cylindrical aluminum tubing about which a cork or rubber outer surface is adhesively affixed thereto so as to provide a handle component 216. A proximal end of handle component 216 includes a component connector 58 having a threaded shank, or shaft 60 that can be removably received in complementary relation within a threaded bore on a handle, such as threaded bore 48 on handle component 16 of handle 12 (see FIG. 2). A distal end of handle component 216 includes a similar component connector 230 into which adjustable weight assembly 34 is threadingly received to affix an array 32 of corrector weights. Accordingly, component connector 230 on the distal end of handle component 216 enables the removable attachment of a component such as an adjustable weight assembly 34 or an extension handle component, such as handle component 150 (of FIG. 6) or handle component 50 (of FIG. 5). Hence, extension handle component 50 can be further extended by adding another extension handle component onto a distal end of handle component 16.

FIG. 6 illustrates construction of an alternative extension handle component 150 over that depicted in FIG. 5. Extension handle component 150 includes a reel seat 238 onto which a reel, such as a fly fishing reel 140 can be removably affixed between a pair of collars 52 and 54 via a threaded nut 54. Reel seat 238 is provided along a bottom edge of handle component 316. A proximal end of handle component 316 includes a component connector 158 having a threaded stud, or shank 60 that is received within a complementary female component connector provided on a distal end of a handle component, such as handle component 16 (see FIGS. 1-2), 116 (see FIGS. 3-4), or extension handle component 216 (see FIG. 5). A distal end of handle component 316 includes a component connector 331 for removably receiving an adjustable weight assembly 34 having an array 32 of adjuster weights. Optionally, another extension handle component can be affixed onto a distal end of handle component 316.

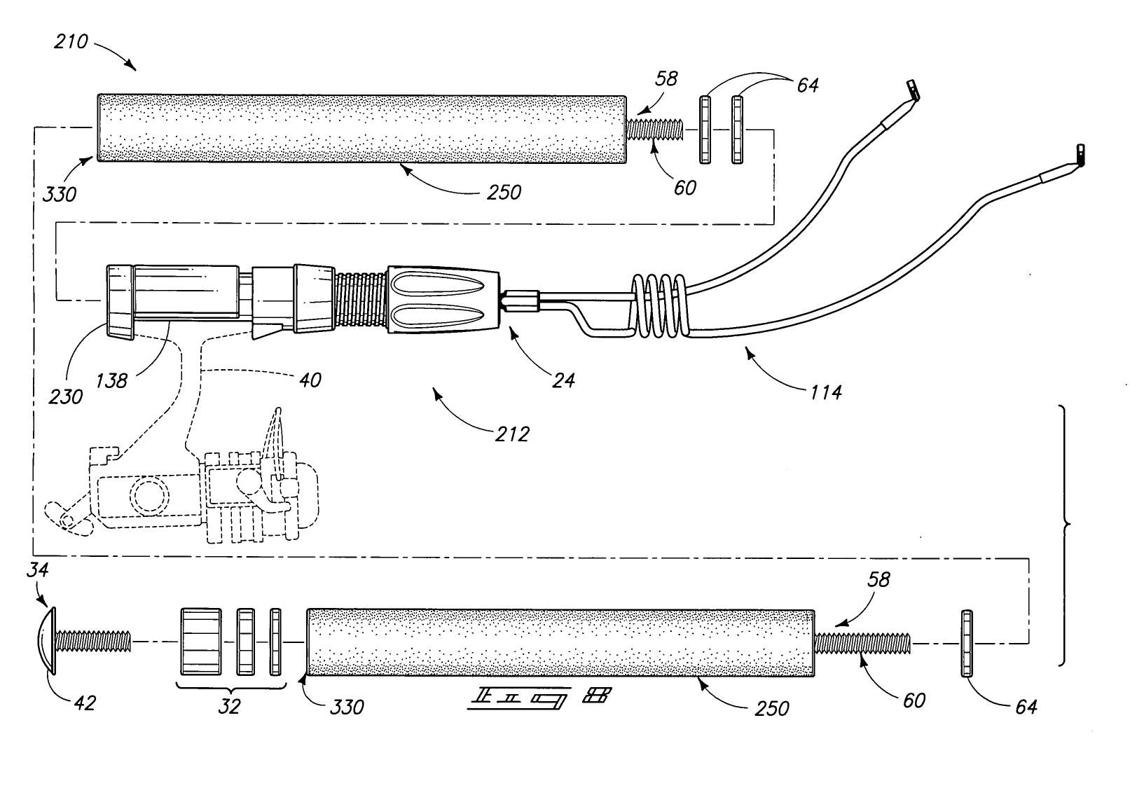

FIG. 7 illustrates the placement of an extension handle component 250 onto a distal end of handle component 116 on handle 112. A component connector 130 is provided in the distal end of handle component 116 in which a threaded bore is provided within a bronze slug (not shown) into which threaded stud 60 is threadingly engaged. Threaded stud 60 is provided by a component connector 58 on the proximal end of extension handle component 250. A spacer washer 64 (having a central bore and an outer die that is complementary with the extension handle component 250 and handle component 116) is received over threaded stud 60 during assembly of component 250 onto component 116. Component connectors 58 and 66 are then rotated into threaded engagement therebetween. Extension handle component 250 can be easily removed from handle component 116 by unthreading stud 60 from within component connector 66. A headed fastener 42 is received through one or more adjuster weights within array 32 in order to secure adjustable weight assembly 34 onto a distal end of extension handle component 250. Alternatively, another extension handle component can be mounted onto a distal end of extension handle component 250 to further lengthen handle 112. Such a further extension can be similar to extension handle component 50 (see FIG. 5) or extension handle component 150 (see FIG. 6).

As configured in FIG. 7, handle 112 is rotated so as to provide reel seat 138 in a downward configuration, with a spinning reel 40 removably affixed thereto. However, it is understood that handle component 116 can be rotated in an upward direction to present reel seat 138 thereatop for receiving a casting reel thereon (not shown).

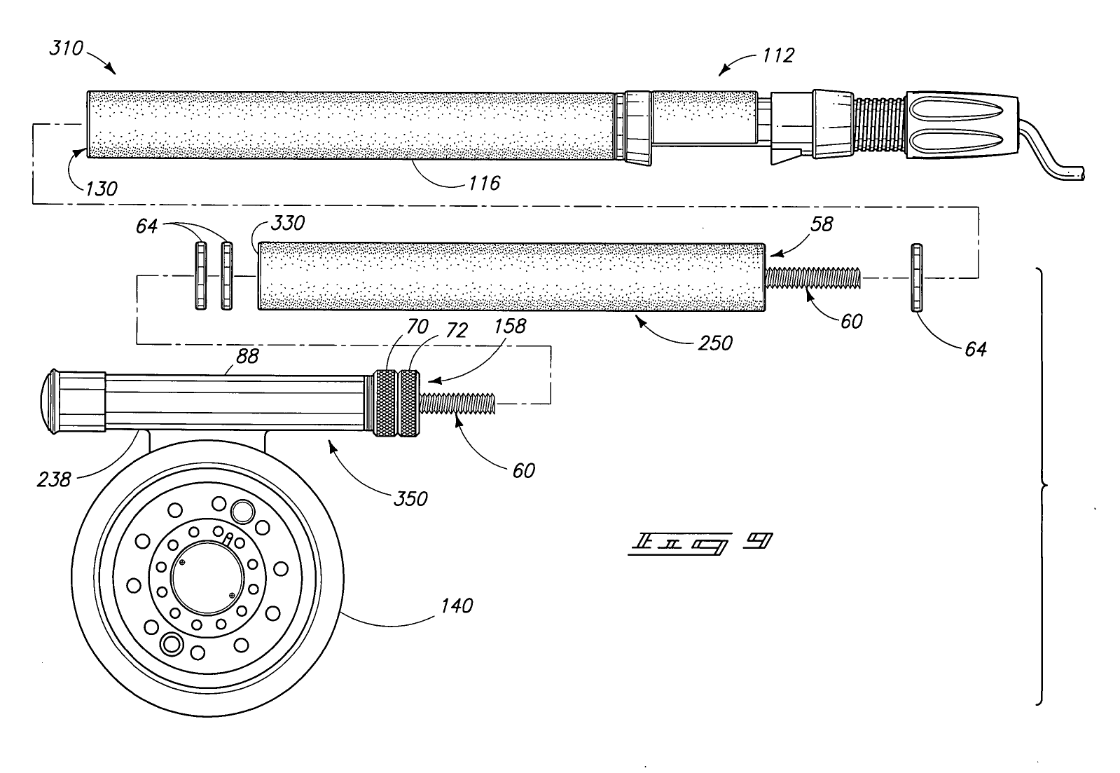

FIG. 8 illustrates an alternative construction for a fishing pole 210 utilizing features of the present invention. More particularly, a pair of extension handle components 250 are affixed in series onto a distal end of a fishing pole handle 212 in order to lengthen handle 212 to facilitate user operation when retrieving relatively large fish. A twin tip rod 114 is removably affixed via a connector assembly 24 from rod 212. In the depicted configuration, a reel seat 138 is provided along a bottom portion of handle 212 for receiving a spin casting reel 40. A distal end of rod 212 has a component connector 230 with a threaded bore (not shown) sized to receive a threaded stud 60 on a component connector 58 provided on a proximal end of a first handle component 250. A pair of spacer washers 64 are first received onto threaded stud 60 before receiving threaded studs 60 into threaded engagement within component connector 230. Spacer washers 64 are each preferably formed form a piece of brass or bronze, or other solid metal. The distal end of extension handle component 250 has a component connector 30 with a threaded bore (not shown) into which a threaded stud 60 on another extension handle component 50 is threadingly engaged to further extend the length of handle 212. More particularly, stud 58 on component connector 58 for a second extension handle component 250 is engaged to a single spacer washer 64 into the threaded bore of component connector 30 on the first extension handle 250. The distal end of the second extension handle component 250 includes a component connector 30 with a threaded bore (not shown) into which threaded fastener 42 is received along with an array 32 of corrector weights for engagement onto the distal end of extension handle component 250.

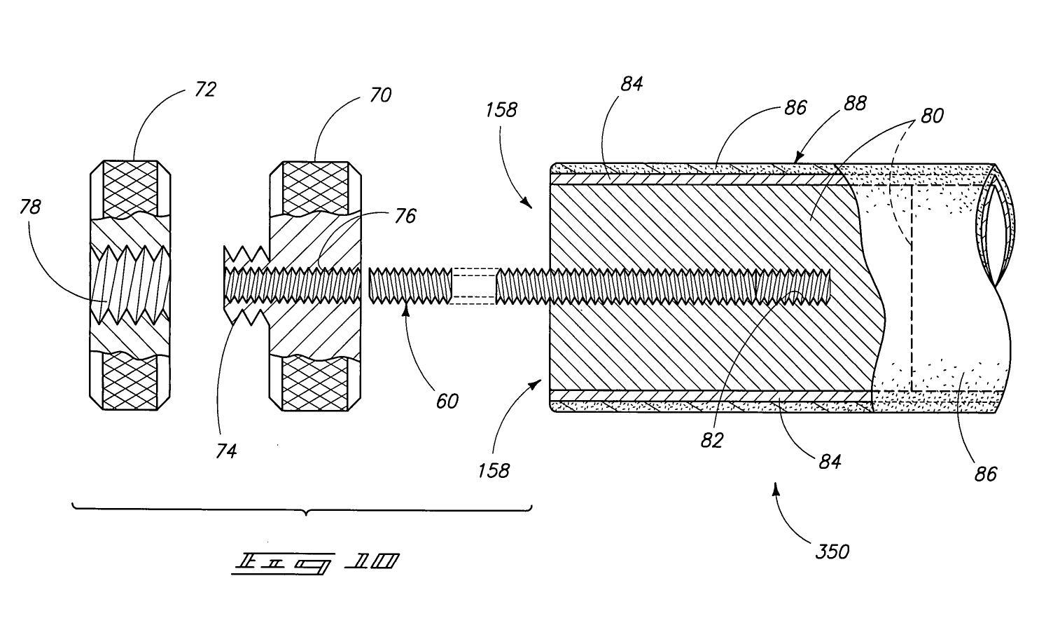

FIG. 9 illustrates a further alternative configuration for a fishing pole 310 having features of the present invention including the serial affixation of an extension handle component 250 onto a distal end of handle component 116 for fishing pole handle 112. A further extension handle component 350 is subsequently affixed onto a distal end of handle extension component 250. Component 350 enables a user to convert fishing pole 310 from a spin casting configuration to a fly fishing configuration.

Extension handle component 350 includes a second reel seat 238 onto which a fishing reel, such as a fly fishing reel 140 can be removably affixed. A component connector 130 having a threaded bore (not shown) is provided on a distal end of handle component 116 sized to removably receive enthreaded engagement a threaded stud 60 on a component connector 50 on the proximal end of extension handle component 250. A single spacer washer 64 is also loaded onto stud 60 prior to assembly between components 116 and 250.

A distal end of extension handle component 250 includes a component connector 330 having a threaded bore (not shown) configured to receive the threaded stud 60 on a component connector 158 on the proximal end of extension handle component 350. Stud 60 is received through a pair of spacer washers 64 before being threadingly engaged into component connector 330. A pair of adjuster nuts 70 and 72 are also provided along a proximal end of extension handle component 350 where they ride in threaded engagement atop threaded stud 60 to adjust the abutment position of extension handle component 50 against component connector 330 on handle 250. In this way, extension handle component 350 can be threaded into engagement with extension handle component 250 so as to properly align the reel seat 238 in correct rotary position relative to the rod on the fishing pole 310 by adjusting the abutment thread position by moving threaded nuts 70 and 72 (see FIG. 10 for further detail).

FIG. 10 illustrates the construction of the adjuster nuts 70 and 72 on a rotational lock and alignment assembly that are received over threaded stud 60. The assembly provides a proper axial alignment when affixing handle component 350 (see FIG. 9) onto a fishing pole handle so as to align the reel seat relative to the rod. As shown in FIG. 10, threaded stud 60 is received within a complementary threaded bore 82 of a brass, or bronze slug 80. Slug 80 is sized to be received and adhesively affixed (via epoxy or Locktite) within an aluminum tube 84 that forms the main structural element of a particular handle assembly. A cork or rubber grip 86 is then adhesively affixed onto an exterior of aluminum tube 84 so as to provide a generic handle component 88. Handle component 88 can represent handle component 16, 116, 216, and 316 as previously discussed. Optionally, slug 80 can be crimped, welded, brazed, or soldered within tube 84. Additionally, threaded stud 60 is adhesively affixed within female threaded bore 82 using an adhesive, such as an epoxy or Locktite adhesive fastener.

Nut 72 has a threaded bore 78 that mates with a male threaded stud 74 on nut 70. Stud 60 is received within a threaded bore 76 of nut 70. By adjusting the threaded position of nut 72 relative to nut 70, the distance between component connector 158 and an adjacent component connector on the fishing pole handle, or extension handle component can be adjusted such that a handle with a reel seat will lock into engagement with the reel seat provided in a proper alignment with a rod of the fishing pole.

As shown in FIG. 10, threaded stud 60 is sized to extend all the way through nuts 70 and 72 and into a complementary threaded bore that is provided within a component connector on an adjacent handle or within an adjacent extension handle component.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

The invention claimed is:

1. A fishing pole handle, comprising:
a first handle component having a first reel seat, a rod connector provided at a proximal end, and a first component connector provided at a distal; and
a second handle component having a second reel seat and a second component connector provided at a proximal end.

2. The fishing pole handle of claim 1, wherein the first handle component is a handle member.

3. The fishing pole handle of claim 1, wherein the second handle component is a handle extension member.

4. The fishing pole handle of claim 1, wherein the second handle component is a fly fishing handle extension member.

5. The fishing pole handle of claim 4, wherein the second reel seat comprises a fly fishing reel seat.

6. The fishing pole handle of claim 1, wherein second handle component further comprises a third component connector provided at a distal end.

7. The fishing pole handle of claim 6, wherein the third component connector is configured to receive an adjustable weight balance system.

8. The fishing pole handle of claim 6, further comprising a third handle component having fourth component connector provided at a proximal end configured to connect with the third component connector of the second handle component.

9. The fishing pole handle of claim 1, wherein the second handle component comprises an end position adjustment interface configured to align rotary position of the second reel seat relative to the first handle component.

10. A fishing pole handle, comprising:
a first handle component having a first reel seat, a rod connector provided at a proximal end, and a first component connector provided at a distal; and
a second handle component having a second component connector provided at a proximal end.

11. The fishing pole handle of claim 10, wherein the second handle component comprises a third component connector provided at a distal end, and further comprising a third handle component having a fourth component connector configured to mate with the third component connector.

12. The fishing pole handle of claim 10, wherein the reel seat is provided along a bottom edge of the first handle component.

13. The fishing pole handle of claim 10, wherein the reel seat is provided along a top edge of the handle component.

14. The fishing pole handle of claim 10, further comprising a hinge provided along the first handle component between the reel seat and a distal end of the first handle component.

15. The fishing pole handle of claim 10, wherein the reel seat comprises a first reel seat, and further comprising a second reel seat provided on the second handle component.

16. A fishing pole, comprising:
a rod;
a handle connected with the rod and having a first component connector at a distal end; and
a handle extension having a second component connector provided at a proximal end and configured to removably mate the handle extension onto the handle.

17. The fishing pole of claim 16, further comprising a reel seat provided on the handle extension.

18. The fishing pole of claim 17, wherein the reel seat comprises a fly fishing reel seat.

19. The fishing pole of claim 16, further comprising another handle extension, wherein the one handle extension comprises a third component connector at a distal end of the one handle extension and the another handle section comprises a fourth component connector at a proximal end of the second of the another handle section configured to mate in engagement with the third component connector.

20. The fishing pole of claim 19, further comprising a fifth component connector provided at a distal end of the another handle extension configured to removably receive a fishing pole component.
